(19) United States
(12) Patent Application Publication
(10) Pub. No.: US 2002/0013932 A1
(43) Pub. Date: Jan. 31, 2002

(54) Continuous parametric model for circuit simulation

(76) Inventors: William U. Liu, Plano, TX (US); Mi-Chang Chang, Hsin-chu (TW)

Correspondence Address: TEXAS INSTRUMENTS INCORPORATED, P O BOX 655474, M/S 3999, DALLAS, TX, 75265

(21) Appl. No.: 09/754,811

(22) Filed: Jan. 4, 2001

Related U.S. Application Data
(60) Provisional application No. 60/174,491, filed on Jan. 4, 2000.

(51) Int. Cl. G06F 17/50

(52) U.S. Cl. 716/4; 716/5

(57) ABSTRACT

A continuous parametric model is provided for a physical circuit element that includes a base model which exhibits a discontinuity over an allowable range of model parameters or a discontinuity in the first derivative of the allowable range of model parameters. At least one compensation function can be provided to remove the discontinuities of the base model over the allowable range of parametric values and at least one compensation constant can be included to prevent a first derivative of the base model from exhibiting discontinuities over the allowable range of parameters, whereby the base model is rendered continuous. The resulting continuous parametric model provides enhanced simulation/analysis performance when compared to traditional smoothing functions.

### BACKGROUND OF THE INVENTION

In the synthesis and analysis of electronic circuits and systems, computer design tools are pervasive. Circuit analysis software, such as various embodiments of the public domain simulation engine SPICE, allow engineers to efficiently test complex circuit designs using computer-based models of the circuits and circuit elements, prior to building physical prototypes. As these computer-based tools evolve, all but final design verification will ultimately be performed using computer-based modeling.

However, as anyone with experience in using computer aided design tools is well aware, these tools are still somewhat limited. For example, a significant problem with many SPICE models is that they are designed in a piecewise fashion with different modeling equations characterizing different regions of the model. For example, a transistor model may include a parametric model for a voltage transfer function that has a first mathematical representation for a sub-threshold region, a second mathematical representation for a linear region of operation and yet a third mathematical representation to describe the saturation region of the circuit. This modeling approach can present problems in the continuity of device parameters (such as capacitances) as well as in the continuity of the derivatives of the parametric models.

Numerical techniques have been proposed to deal with the discontinuities which result from piecewise linear modeling. A common solution for such piecewise linear models is to create a smoothing function. The purpose of the smoothing function is to maintain the continuity of the circuit model over an expected range of values.

A popular smoothing function, representing the effective voltage of an electrical component, is set forth below in Equation 1.

$${V}_{eff} = {V}_{0} - \frac{1}{2} [ ( {V}_{0} - V - δ ) + \sqrt{{( {V}_{0} - V - δ )}^{2} + 4 \cdot δ \cdot {V}_{0} ]} \qquad ( 1 )$$

Equation 1 exhibits the properties that

$${V}_{eff} = \{ \begin{matrix}{V}_{0} & if V ⪢ {V}_{0} \\ V & if V ⪡ {V}_{0}\end{matrix} \qquad ( 2 a )$$

and

V_{eff}=0 if V=0 and V₀>0 (2b)

Property 2(b) is an important attribute of a smoothing function. For example, the smoothing function of Equation 1 can be used to model the drain-to-source voltage (V_{ds}) of a FET transistor, in the following manner:

$$\begin{matrix}{V}_{dseff} = {V}_{dsat} \{ - \frac{1}{2} ( {V}_{dsat} - {V}_{ds} - δ ) + \\ \sqrt{{( {V}_{dsat} - {V}_{ds} - δ )}^{2} + 4 \cdot δ \cdot {V}_{dsat}} \}\end{matrix} \qquad ( 3 )$$

The smoothing function of equation 3 has the property that at V_{ds}=0, the effective drain-to-source voltage (V_{dseff}) is also zero. Additionally, in accordance with the property given in Eq. (2a), V_{dseff} approaches V_{dsat} if V_{ds} is much greater that V_{dsat}, but becomes V_{ds} itself if V_{ds} is smaller that V_{dsat}.

The constant δ is used to provide a smooth transition at the corner point of V=V₀. If V_{eff} were defined as Eq.(1) except with δ=0, i.e.,

$${V}_{eff} = {V}_{0} \frac{1}{2} \{ ( {V}_{0} - V ) + \sqrt{{( {V}_{0} - V )}^{2}} \} \qquad ( 4 )$$

then the resulting function exhibits a piecewise continuous nature and its first derivative would be discontinuous at the point V=V₀.

A typical value used for δ is 0.02. For a certain case when V₀=1, V_{eff} obtained from Eq. (1) as a function of V is shown in FIG. 1. FIG. 1 is a graph which illustrates that V_{eff} is smooth and achieves both properties specified in Eq. (2). However, there are two severe drawbacks to the smoothing function of Eq. (1). First, when V₀ assumes a negative value a discontinuity is encountered. FIG. 2 is a graph which illustrates the same calculations used to generate the graph of FIG. 1, except that V₀ is equal to −1 in this example. FIG. 2 demonstrates that even though V_{eff} converges properly to V₀ when V+V₀, a discontinuity 200 occurs near the turning point.

The second problem of Eq. (1) results when V₀ is identically zero. In this case, V_{eff} calculated from Eq. (1) is shown in the graph of FIG. 3. FIG. 3 illustrates that V_{eff} is piecewise continuous and, therefore, that the first derivative is discontinuous at V₀=0. This problem results from the fact that if V₀=0, the term 4$δ$V₀ inside the square root ceases providing the smoothing action because it is identically zero.

When the models used by a simulation engine exhibit discontinuities, the resulting simulation may yield incorrect results, fail to converge or even encounter run-time computer errors. While known smoothing functions reduce the likelihood of such occurrences, care must still be taken in determining the range of input values which are applied to many circuit element models. Thus, there remains a need for an improved method of modeling component parameters such that the aforementioned discontinuities are avoided and a broader range of input variables can be applied in the resulting circuit models.

### SUMMARY OF THE INVENTION

Accordingly, a need has arisen in the art for an improved circuit models for use with simulation and analysis systems.

In accordance with the present invention, a method of generating a continuous parametric model of an electronic circuit parameter having a base model includes the step of determining whether the base model exhibits at least one discontinuity over an allowable range of parameters. If the base model exhibits at least one discontinuity,

at least one compensation function is applied to prevent the base model from exhibiting such discontinuities over the allowable range of parameters. The method also includes the step of determining whether the first derivative of the base model exhibits at least one discontinuity over the allowable range of parameters. If the first derivative of the base model exhibits at least one discontinuity, at least one compensation constant is applied to prevent a first derivative of the base model from exhibiting discontinuities over the permissible parametric range.

Also in accordance with the present invention, a continuous parametric model of a physical circuit element is generated from a base model that defines a piecewise linear representation of the circuit element and exhibits at least one discontinuity over an allowable range of model parameters and/or exhibits a discontinuity in the first derivative of the allowable range of model parameters. At least one compensation function is included to prevent the continuous parametric model from exhibiting discontinuities over a permissible parametric range of positive and negative values. At least one compensation constant is included to prevent a first derivative of the continuous parametric model from exhibiting discontinuities over the permissible parametric range.

Technical advantages of the present invention include providing improved component models for circuit simulators. In particular, the resulting continuous parametric models and their derivatives are free of discontinuities.

Other technical advantages of the present invention will be readily apparent to one skilled in the art from the following figures, descriptions, and claims.

### BRIEF DESCRIPTION OF THE DRAWINGS

For a more complete understanding of the present invention and advantages thereof, reference is now made to the following description taken in conjunction with the accompanying drawings, wherein like reference numerals represent like parts, in which:

FIG. 1 is a graph of a smoothing function for an exemplary circuit parameter (V_{eff}), as modeled in the prior art.

FIG. 2 is a graph of a smoothing function for an exemplary circuit parameter (V_{eff}), as modeled in the prior art.

FIG. 3 is a graph of a smoothing function for an exemplary circuit parameter (V_{eff}), as modeled using a smoothing function known in the prior art.

FIG. 4 is a block diagram of a circuit modeling and simulation system.

FIG. 5 is a flow chart illustrating a method of generating an enhanced continuous parametric model for a circuit element in accordance with the present invention.

FIG. 6 is a graph of an exemplary circuit parameter (V_{eff}) as modeled in accordance with the present invention.

FIG. 7 is a graph of an exemplary circuit parameter (V_{eff}) modeled with an enhanced continuous parametric model in accordance with the present invention.

### DETAILED DESCRIPTION OF THE INVENTION

The preferred embodiments of the present invention and the attendant advantages thereof are best understood by referring now in more detail to the drawings in which like numerals refer to like parts.

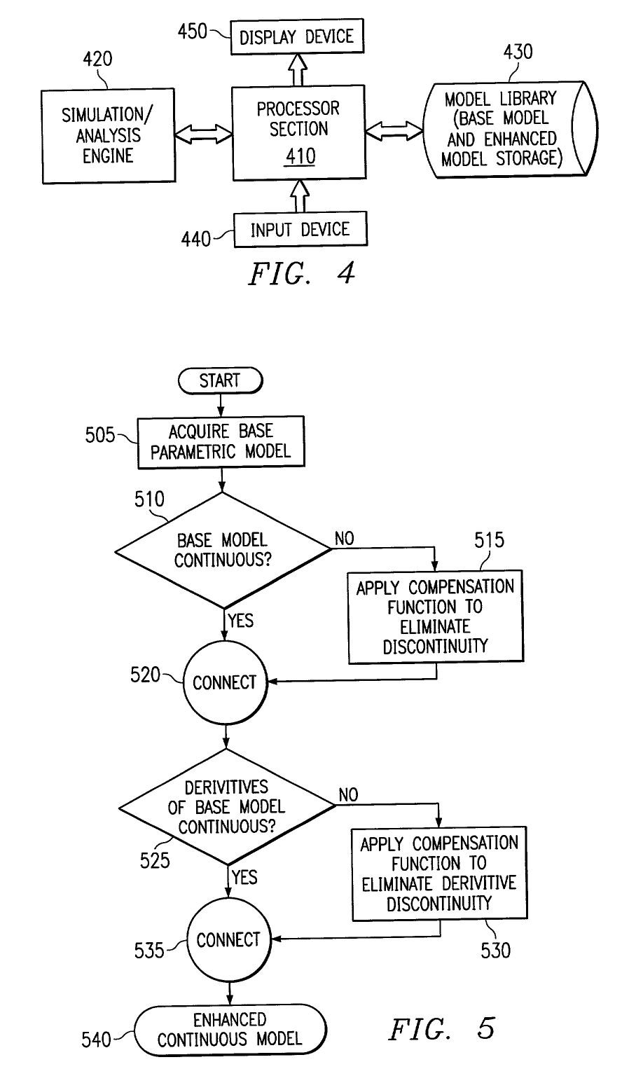

FIG. 4 is a simplified block diagram illustrating an exemplary computer system which can be used to generate and use enhanced component models to model and simulate electronic circuits and systems in accordance with the present invention. The present invention is not specific to any particular computing platform, therefore, the computer system can take the form of a personal computer, workstation, network terminal or other computer devices. Generally, the system includes a processor section 410 which is operatively coupled to one or more computer readable mass storage devices such as disk drives, CD-rom drives, tape drives and the like. The processor 410 section can access the storage devices and import digital data representing simulation/analysis engine software 420 and one or more component model libraries 430. While shown in FIG. 4 as separate structures, the program data for the simulation engine 420 and the data for the model library 430 can reside on a common storage device. The system will generally include an input device 440, preferably including a keyboard and digital pointer device such as a mouse, trackball, light pen, touch screen input device and the like. The system will also include a display device 450, such as a CRT screen. The input device 440, processor section 410 and display device 450 preferably cooperate to establish a graphical user interface (GUI). Of course, numerous variations on these basic components are possible without deviating from the present invention.

In conventional circuit modeling, such as Compact 7 and SPICE modeling, circuit components are described by models. The models, in turn, are generally a collection of mathematical representations of various device parameters which characterize the component, such as input/output transfer functions. Such mathematical representations are referred to herein as parametric models. Thus a particular component model is formed with one or more parametric models. In this disclosure, the term base parametric model refers to parametric models, such as that described in connection with Eq. 1, which exhibits at least one discontinuity or the derivative of which exhibits at least one discontinuity.

Referring to FIG. 5, the method of generating an enhanced continuous parametric model begins with the acquisition of a base parametric model (step 505). The base parametric model is analyzed to determine whether the model is continuous over the desired full range of variables (step 510). If the base parametric model is not continuous, at least one compensation function is applied to eliminate the discontinuity (step 515). If the base parametric model is continuous, the method advances through logical connector 520 to determine whether the derivatives of the base parametric base model are continuous (step 525). If the derivatives are not continuous, a compensation constant is applied to the parametric model to eliminate the derivative discontinuity (step 530). After the derivatives have been found to be continuous, or have been compensated to be continuous, the method concludes with the result being an enhanced continuous parametric model (step 540). The enhanced continuous parametric model can be stored in model library 430 for use by the stimulation/analysis engine software 420.

In accordance with steps outlined in FIG. 5, a base parametric model is transformed into an enhanced continuous parametric model. As an example of the present invention, the base parametric model of Eq. 1 can be transformed into an enhanced continuous parametric model in accordance with the present invention.

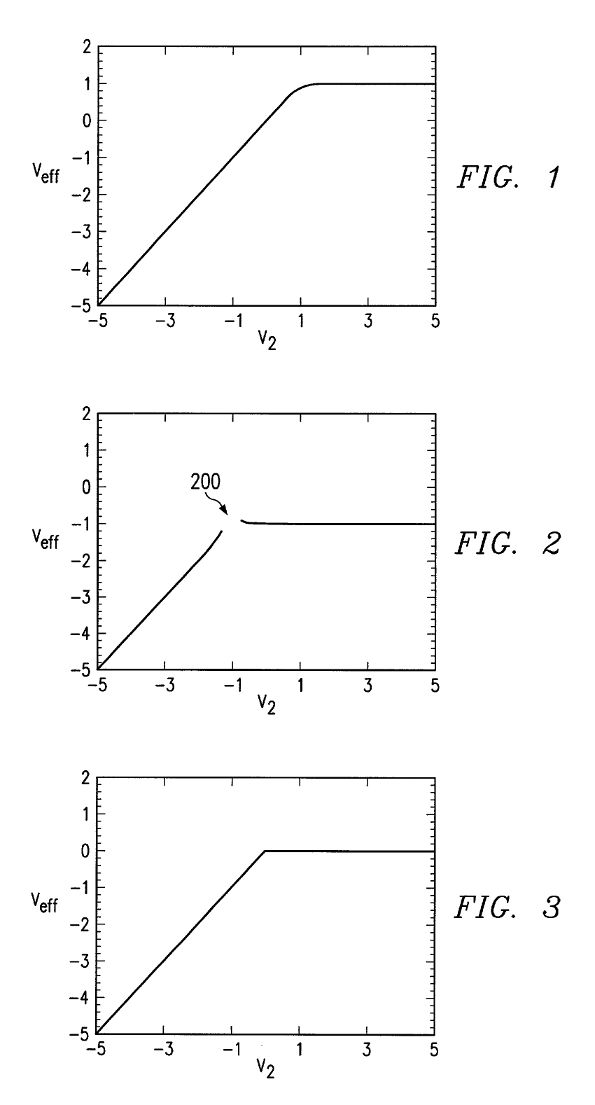

As noted in connection with FIG. 2, Eq. 1 can exhibit a discontinuity when V₀ is less than zero. In removing the discontinuity in Equation 1, the term δ, a constant, can be replaced with a variable, 0, such as a mathematical equation. The term θ can take the form of a number of functions which exhibit a small value when compared to V₀. Equation 5, which is set forth below, illustrates this initial substitution.

$${V}_{eff} = {V}_{0} - \frac{1}{2} \{ ( {V}_{0} - V - θ ) + \sqrt{{( {V}_{0} - V - θ )}^{2} + 4 θ {V}_{0}} \} \qquad ( 5 )$$

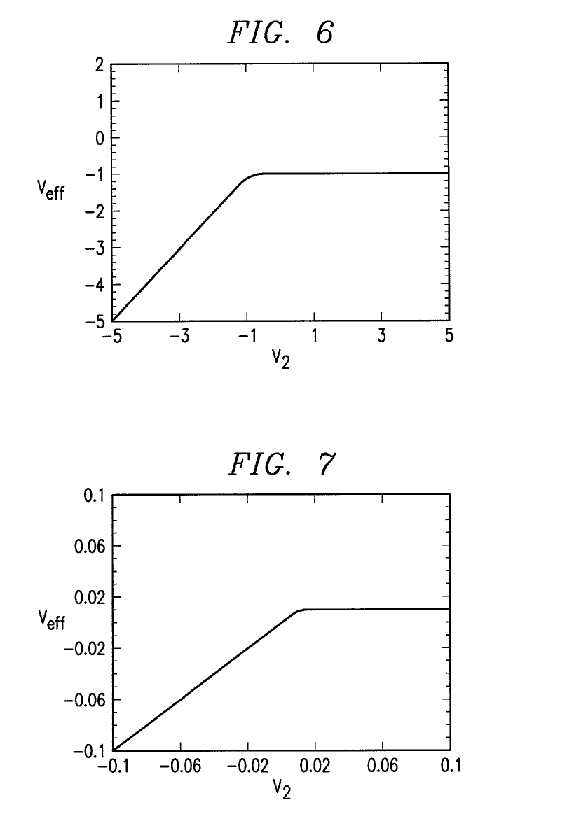

In Eq. (5), the function designated as θ is referred to as a compensation function. A simple example of a compensation function which removes the initial discontinuities encountered in Eq. 1 is defined in the following manner:

$${V}_{eff} = \{ \begin{matrix}δ & if {V}_{0} > θ \\ - δ & if {V}_{0} < θ ,\end{matrix} \qquad ( 6 )$$

where δ is any arbitrarily small number, such as 0.02, as used in connection with Eq. 1. With this compensation function, the discontinuity problem illustrated in FIG. 2 is removed. However, the function of Eq. (6) is itself not continuous at V₀=θ. An alternative compensation function can be defined as:

$$θ ( {V}_{0} ) = \frac{{V}_{0}}{K} \qquad ( 7 )$$

where K is any positive number substantially greater than unity. FIG. 6 is a graph of V_{eff} of Eq. (5) with θ from Eq. (7) and K=100. As the graph of FIG. 6 illustrates, such an enhanced parametric model is satisfactory even when V₀ is negative.

The enhanced parametric model set forth above in Equation 5, though representing an improvement over the smoothing function of Eq. 1, still exhibits a discontinuity when V₀ is equal to zero. To correct for this effect, an enhanced parametric model of the present invention can be further defined as follows:

$${V}_{eff } = {V}_{0}^{*} - \frac{1}{2} \{ ( {V}_{0}^{*} - V - θ ) + \sqrt{{( {V}_{0}^{*} - V - θ )}^{2} + 4 θ {V}_{0}^{*}} \} , \qquad ( 8 )$$

where V₀* includes a second compensation function to modify the terms with a V₀ component as follows:

V₀*=V₀+Δ●exp(−V₀²) (9)

In this manner, V₀* does not exhibit a value equal to zero even when V₀ is equal to zero. The constant parameters are preferably selected to be small, such that V₀* approaches V₀ when V₀ is large, as set forth by the requirement of Eq. 2b. It will be appreciated that the expression for V₀^{*} given Eq. (8) is merely exemplary and that any number of specific functions exhibiting the aforementioned properties will suffice, thus, satisfying step 515.

While the enhanced parametric model of Eq. (8) is substantially continuous, this function is only piecewise continuous when V₀=0. Therefore, the derivative of this function will not be continuous at this point (step 525). In this case, the cause is that at V₀=0, 4$V₀$θ is identically zero. To avoid this situation, a compensation constant, [symbol] , can be applied to the square root term of Eq. (8) in addition to the terms 4$V₀$θ and (V₀−V−θ)².

Applying a mathematical identity,

(V₀−θ)²+4●θ●V₀+2●V₀●Δ+Δ²=(V₀+θ+Δ)², (10)

an enhanced parametric base model can be defined as:

$$\begin{matrix}{V}_{eff } = {V}_{0} - \frac{1}{2} \{ ( {V}_{0} - V - θ - Δ ) + \\ \sqrt{{( {V}_{0} - V - θ )}^{2} + 4 θ {V}_{0} + 2 {V}_{0} Δ + 2 θ \cdot Δ + {Δ}^{2}} \}\end{matrix} \qquad ( 11 )$$

With [symbol] =0.01, for example, the terms inside the square root other than (V₀−V−θ)² will never be zero even though V₀=0. Recognizing that the overall value within the square root can be negative when the value of V₀ is very small, and that the property dictated by Eq. (2a) needs to be fulfilled only when V₀ is positive, the parametric equation model of Eq. 1 can be further refined as:

$$\begin{matrix}{V}_{eff} = {V}_{0} - \frac{1}{2} \{ ( {V}_{0} - V - θ - Δ ) + \\ \sqrt{{( {V}_{0} - V - θ - )}^{2} + 4 θ {V}_{0} + 2 \sqrt{{V}_{0}^{2}} Δ + 2 \sqrt{{θ}^{2}} \cdot Δ + {Δ}^{2}} \} ,\end{matrix} \qquad ( 12 )$$

which is the desired enchanced continuous parametric model.

Using the resulting continuous parametric model of Eq. (12) along with the compensation function θ, defined in Eq. (7), a desirable output is achieved whether the input (in the example, V₀) is positive or negative. Even in the case when V₀=0, the enhanced parametric model of Eq. (12) produces the desirable smooth result, which is illustrated in the graph of FIG. 7.

While the continuous parametric model of Eq. (12) represents a voltage, the terms V_{eff}, V₀, and V can be substituted with other parametric variables such as current (I), Power (P), Resistance (R), capacitance (C) and the like. In addition, while the methodology of the present invention was demonstrated in connection with the base model of Eq. (1), numerous other base models can be transformed into continuous parametric models in accordance with the present invention.

Although the present invention has been described with several embodiments, various changes and modifications may be suggested to one skilled in the art. It is intended that the present invention encompass such changes and modifications as fall within the scope of the appended claims.

What is claimed is:

1. A method of generating a continuous parametric model of an electronic circuit parameter having a base model, comprising the steps:
determining whether the base model exhibits at least one discontinuity over an allowable range of parameters;
if the base model exhibits at least one discontinuity, applying at least one compensation function to prevent the base model from exhibiting discontinuities over the allowable range of parameters;
determining whether the first derivative of the base model exhibits at least one discontinuity over the allowable range of parameters; and
if the first derivative of the base model exhibits at least one discontinuity, applying at least one compensation constant to prevent a first derivative of the base model from exhibiting discontinuities over the permissible parametric range.

2. The method of claim 1 wherein the base model takes the form
$${A}_{eff} = {A}_{0} - \frac{1}{2} [ ( {A}_{0} - A - δ ) + \sqrt{{( {A}_{0} - A - δ )}^{2} + 4 \cdot δ \cdot {A}_{0} ] .}$$

3. The method of claim 2, wherein the at least one compensation function is substituted into the base model in place of the constant term δ in the base model.

4. The method of claim 3, wherein the at least one compensation function takes the form of
$$θ ( {A}_{0} ) = \frac{{A}_{0}}{K} .$$

5. The method of claim 4, wherein the at least one compensation function further comprises a second compensation function which is substituted for the term A₀.

6. The method of claim 5, wherein the second compensation function takes the form, A₀^{*=A}₀+Δ●exp(−A₀²), where Δ is a constant having a value significantly less than A₀.

7. The method of claim 6, wherein the compensation constant Δ is applied to the base model and the resulting enhanced continuous parametric model is represented as
$${A}_{eff} = {A}_{0} - \frac{1}{2} \{ ( {A}_{0} - A - θ - Δ ) + \sqrt{{( {A}_{0} - A - θ )}^{2} + 4 θ {A}_{0} + 2 \sqrt{{A}_{0}^{2}} Δ + 2 \sqrt{{θ}^{2}} \cdot Δ + {Δ}^{2}} \} .$$

8. The method of claim 7, wherein A_{eff}, A₀ and A represent voltage parameters of an electronic component.

9. The method of claim 7, wherein A_{eff}, A₀ and A represent current parameters of an electronic component.

10. The method of claim 7, wherein A_{eff}, A₀ and A represent power parameters of an electronic component.

11. A continuous parametric model of a physical circuit element comprising:
a base model, said base model defining a representation of the circuit element, said base model exhibiting at least one of a discontinuity over an allowable range of model parameters and a discontinuity in the first derivative of the allowable range of model parameters;
at least one compensation function to remove the discontinuities of the base model over the allowable range of parametric values; and
at least one compensation constant to prevent a first derivative of the base model from exhibiting discontinuities over the allowable range of parameters.

12. The continuous parametric model method of claim 11, wherein the base model takes the form
$${A}_{eff} = {A}_{0} - \frac{1}{2} [ ( {A}_{0} - A - δ ) + \sqrt{{( {A}_{0} - A - δ )}^{2} + 4 \cdot δ \cdot {A}_{0} ] .}$$

13. The continuous parametric model method of claim 12, wherein the at least one compensation function is substituted into the base model in place of the constant term δ in the base model.

14. The continuous parametric model method of claim 13, wherein the at least one compensation function takes the form of
$$θ ( {A}_{0} ) = \frac{{A}_{0}}{K} .$$

15. The continuous parametric model method of claim 14, wherein the at least one compensation function further comprises a second compensation function which is substituted for the term A₀.

16. The continuous parametric model method of claim 15, wherein the second compensation function takes the form A₀^{*}=A₀+Δ●exp(−A₀²), where Δ is a constant having a value significantly less than A₀.

17. The continuous parametric model method of claim 16, wherein the compensation constant Δ is applied to the base model and the resulting enhanced continuous parametric model is represented as
$${A}_{eff} = {A}_{0} - \frac{1}{2} \{ ( {A}_{0} - A - θ - Δ ) + \sqrt{{( {A}_{0} - A - θ )}^{2} + 4 θ {A}_{0} + 2 \sqrt{{A}_{0}^{2}} Δ + 2 \sqrt{{θ}^{2}} \cdot Δ + {Δ}^{2}} \} .$$

18. The continuous parametric model method of claim 17, wherein A_{eff}, A₀ and A represent voltage parameters of an electronic component.

19. The continuous parametric model method of claim 17, wherein A_{eff}, A₀ and A represent current parameters of an electronic component.

20. The continuous parametric model method of claim 17, wherein A_{eff}, A₀ and A represent power parameters of an electronic component.
